(19) United States
(12) Patent Application Publication
(10) Pub. No.: US 2026/0086793 A1
(43) Pub. Date: Mar. 26, 2026

(54) FIRMWARE UPGRADE METHOD AND APPARATUS, RECEIVING END DEVICE, AND STORAGE MEDIUM

(71) Applicant: CHENGDU CONVENIENTPOWER SEMICONDUCTOR CO., LTD., Sichuan (CN)

(72) Inventors: Jian Deng, Sichuan (CN); Fangming An, Sichuan (CN); Jiamin Zeng, Sichuan (CN)

(21) Appl. No.: 19/103,307

(22) PCT Filed: Mar. 7, 2024
(86) PCT No.: PCT/CN2024/080618

§ 371 Date: Feb. 12, 2025

(30) Foreign Application Priority Data
May 5, 2023 (CN) 202310492165.4

(51) Int. Cl. G06F 8/65

(52) U.S. Cl. CPC G06F 8/65

(57) ABSTRACT

Provided are a firmware upgrade method and apparatus, a receiving end device, and a storage medium, The method includes: if an upgrade message for charging firmware is received during wireless charging, controlling a wireless charging receiving end device and a wireless charging transmitting end device to continue the wireless charging according to a preset original data packet of the charging firmware; updating a pre-stored data packet of the charging firmware in a first storage area according to an upgrade data packet of the charging firmware in the upgrade message during the wireless charging, so as to upgrade the charging firmware; and if the charging firmware is successfully upgraded, controlling the wireless charging receiving end device and the wireless charging transmitting end device to carry out the wireless charging according to the upgraded charging firmware in the first storage area.

### CROSS-REFERENCE TO RELATED APPLICATION

The present disclosure claims the priority to the Chinese patent application with the filling No. 2023104921654 filed with the Chinese Patent Office on May 5, 2023, and entitled “FIRMWARE UPGRADE METHOD AND APPARATUS, RECEIVING END DEVICE, AND STORAGE MEDIUM”, the contents of which are incorporated herein by reference in entirety.

### TECHNICAL FIELD

The present disclosure relates to the field of wireless charging technology and, more specifically, to a firmware upgrade method and an apparatus, a receiving end device, and a storage medium.

### BACKGROUND ART

With the development of wireless charger, wireless charging for wearable devices has become very common.

Due to the advancement of wireless charging protocols and updates to the system requirements of wearable devices, the receiving end chip (RxIC) for wireless charging requires firmware upgrades via over-the-air technology (OTA).

During the existing process of firmware upgrade for the receiving end chip of wireless charging, the receiving end chip needs to be powered through a reverse power supply circuit from the battery of the wearable device, or the receiving end chip is powered via a wired charging method.

However, the reverse power supply circuit increases the size and hardware cost of the wearable device, and the wired charging interface prevents the wearable device from meeting waterproof requirements. For wearable devices without a reverse power supply circuit or a wired charging interface, if energy transfer cannot be conducted during the firmware upgrade process, the firmware upgrade will fail.

### SUMMARY

In view of this, the objective of the present disclosure is to provide a firmware upgrade method and an apparatus, a receiving end device, and a storage medium to maintain energy transfer during the firmware upgrade process and ensure the success of the firmware upgrade.

To achieve at least one of the objectives mentioned above, the technical solution adopted by the present disclosure is as follows.

In a first aspect, the present disclosure provides a firmware upgrade method, which is applied to a wireless charging receiving end device, and the method includes:
controlling, if an upgrade message for charging firmware is received during wireless charging, a wireless charging receiving end device and a wireless charging transmitting end device to continue the wireless charging according to a preset original data packet of the charging firmware;
updating a pre-stored data packet of the charging firmware in a first storage region according to an upgrade data packet of the charging firmware in the upgrade message during the wireless charging, so as to upgrade the charging firmware; and
controlling, if the charging firmware is successfully upgraded, the wireless charging receiving end device and the wireless charging transmitting end device to carry out the wireless charging according to the upgraded charging firmware in the first storage region.

Optionally, the step of controlling a wireless charging receiving end device and a wireless charging transmitting end device to continue the wireless charging according to a preset original data packet of the charging firmware includes:
caching a preset charging bootloader program into a second storage region;
executing the cached preset charging bootloader program in the second storage region; and controlling the wireless charging receiving end device and the wireless charging transmitting end device to continue the wireless charging according to the preset original data packet in the preset charging bootloader program.

Optionally, after the step of updating a pre-stored data packet of the charging firmware in a first storage region according to an upgrade data packet of the charging firmware in the upgrade message during the wireless charging, so as to upgrade the charging firmware, the method further includes:
detecting whether an upgrade success identifier exists;
determining that, if the upgrade success identifier exists, the charging firmware upgrade is successful; and
determining that, if the upgrade success identifier does not exist, the charging firmware upgrade has failed.

Optionally, before the step of detecting whether an upgrade success identifier exists, the method further includes:
verifying the data packet of the charging firmware in the first storage region and the upgrade data packet; and
generating, if the verification passes, the upgrade success identifier.

Optionally, the method further includes:
controlling, if the charging firmware upgrade fails, the wireless charging receiving end device and the wireless charging transmitting end device to continue wireless charging according to a backup data packet of the charging firmware pre-stored in a third storage region;
re-controlling a wireless charging receiving end device and a wireless charging transmitting end device to continue the wireless charging according to the preset original data packet;
re-updating the data packet of the charging firmware in the first storage region according to the upgrade data packet of the charging firmware during the wireless charging, until the charging firmware upgrade is successful.

Optionally, the first storage region and the third storage region are different storage regions within the first memory, and the first memory is a non-volatile memory.

Optionally, the second storage region is a storage region within the second memory, and the second memory is a random-access memory.

In a second aspect, the present disclosure provides a firmware upgrade apparatus, which is applied to a wireless charging receiving end device, and the apparatus includes:
a first charging control module, configured for controlling, if an upgrade message for charging firmware is received during wireless charging, a wireless charging receiving end device and a wireless charging transmitting end device to continue the wireless charging according to a preset original data packet of the charging firmware;
a data packet updating module, configured for updating a pre-stored data packet of the charging firmware in a first storage region according to an upgrade data packet of the charging firmware in the upgrade message during the wireless charging, so as to upgrade the charging firmware; and
a second charging control module, configured for controlling, if the charging firmware is successfully upgraded, the wireless charging receiving end device and the wireless charging transmitting end device to carry out the wireless charging according to the upgraded charging firmware in the first storage region.

Optionally, the first charging control module includes:
a caching unit, configured for caching a preset charging bootloader program into a second storage region; and
a charging control unit, configured for executing the cached preset charging bootloader program in the second storage region; and controlling the wireless charging receiving end device and the wireless charging transmitting end device to continue the wireless charging according to the preset original data packet in the preset charging bootloader program.

Optionally, after the data packet updating module, the apparatus further includes:
a detection module, configured for detecting whether an upgrade success identifier exists;
a determination module, configured for determining that, if the upgrade success identifier does not exist, the charging firmware upgrade has failed; and further configured for determining that, if the upgrade success identifier does not exist, the charging firmware upgrade has failed.

Optionally, before the detection module, the apparatus further includes:
a verification module, configured for verifying the data packet of the charging firmware in the first storage region and the upgrade data packet; and
a generation module, configured for generating, if the verification passes, the upgrade success identifier.

Optionally, the apparatus further includes:
a third charging control module, configured for controlling, if the charging firmware upgrade fails, the wireless charging receiving end device and the wireless charging transmitting end device to continue wireless charging according to a backup data packet of the charging firmware pre-stored in a third storage region;

The first charging control module is further configured for re-controlling a wireless charging receiving end device and a wireless charging transmitting end device to continue the wireless charging according to the preset original data packet.

The data packet updating module is further configured for re-updating the data packet of the charging firmware in the first storage region according to the upgrade data packet of the charging firmware during the wireless charging, until the charging firmware upgrade is successful.

Optionally, the first storage region and the third storage region are different storage regions within the first memory, and the first memory is a non-volatile memory.

Optionally, the second storage region is a storage region within the second memory, and the second memory is a random-access memory.

In a third aspect, the present disclosure further provides a receiving end device, including a processor, a storage medium, and a bus, wherein the storage medium stores program instructions executable by the processor. When the receiving end device operates, the processor communicates with the storage medium via the bus, and the processor executes the program instructions to perform the steps of the firmware upgrade method according to any one of the first aspects.

In a fourth aspect, the present disclosure further provides a computer-readable storage medium, wherein the storage medium stores a computer program. When executed by a processor, the computer program performs the steps of the firmware upgrade method according to any one of the first aspects.

### BRIEF DESCRIPTION OF DRAWINGS

To more clearly illustrate the technical solutions of the embodiments of the present disclosure, the following will briefly introduce the drawings used in the embodiments. It should be understood that the following drawings only show some embodiments of the present disclosure, and therefore they should not be regarded as a limitation on the scope. Those ordinary skilled in the art can also obtain other related drawings based on these drawings without inventive effort.

FIG. 1 is a structural schematic diagram of a firmware upgrade system provided by the embodiments of the present disclosure;

FIG. 2 is a structural schematic diagram of a receiving end chip provided by the embodiments of the present disclosure;

FIG. 3 is the first flowchart of a firmware upgrade method provided by the embodiments of the present disclosure;

FIG. 4 is the second flowchart of a firmware upgrade method provided by the embodiments of the present disclosure;

FIG. 5 is a timing sequence diagram of a preset charging bootloader program sending an original data packet;

FIG. 6 is the third flowchart of a firmware upgrade method provided by the embodiments of the present disclosure;

FIG. 7 is the fourth flowchart of a firmware upgrade method provided by the embodiments of the present disclosure;

FIG. 8 is the fifth flowchart of a firmware upgrade method provided by the embodiments of the present disclosure;

FIG. 9 is a timing sequence diagram of sending a backup data packet;

FIG. 10 is a block diagram of a firmware upgrade method provided by the embodiments of the present disclosure;

FIG. 11 is a schematic structural diagram of a firmware upgrade apparatus provided by the embodiments of the present disclosure; and

FIG. 12 is a structural schematic diagram of a receiving end device provided by the embodiments of the present disclosure.

### DETAILED DESCRIPTION OF EMBODIMENTS

To make the objectives, technical solutions, and advantages of the embodiments of the present disclosure clearer, the technical solutions in the embodiments of the present disclosure will be clearly and completely described below in conjunction with the drawings in the present disclosure. It should be understood that the drawings in the present disclosure are provided solely for illustrative and descriptive purposes and are not intended to limit the scope of protection of the present disclosure. In addition, it should be understood that the schematic drawings are not drawn to a physical scale. The flowcharts used in the present disclosure illustrate operations implemented according to some embodiments of the present disclosure. It should be understood that the operations of the flowchart can be implemented out of sequence, and steps without logical contextual relationships can be reversed in order or implemented simultaneously. Persons skilled in the art, guided by the contents of the present disclosure, may add one or more other operations to the flowchart and may remove one or more operations from the flowchart.

In addition, the described embodiments are only a part of the embodiments of the present disclosure, and not all of them. The components of embodiments of the present disclosure which are generally described and illustrated in the drawings herein can be arranged and designed in a variety of different configurations. Accordingly, the following detailed description of the embodiments of the present disclosure provided in the drawings is not intended to limit the scope of the present disclosure for which protection is claimed but merely represents selected embodiments of the present disclosure. Based on the embodiments in the present disclosure, all other embodiments obtained of those of skill in the art of without making inventive efforts are within the scope of protection of the present disclosure.

To enable those skilled in the art to utilize the content of the present disclosure, the following embodiment is provided in connection with the specific application scenario of “management and control of shared electric vehicles”. For those skilled in the art, the general principles defined herein can be applied to other embodiments and application scenarios without departing from the spirit and scope of the present disclosure. Although the present disclosure is primarily described around the management and control of shared electric vehicles, it should be understood that this is merely an exemplary embodiment.

It should be noted that the term “comprise” as used in the embodiments of the present disclosure may indicate the presence of the features stated thereafter but does not exclude the addition of other features.

During the existing process of firmware upgrade for the receiving end chip of wireless charging, the receiving end chip needs to be powered through a reverse power supply circuit from the battery of the wearable device, or the receiving end chip is powered via a wired charging method.

However, the reverse power supply circuit increases the size and hardware cost of the wearable device, and the wired charging interface prevents the wearable device from meeting waterproof requirements. For wearable devices without a reverse power supply circuit or a wired charging interface, when upgrading using traditional firmware upgrade methods, the firmware upgrade fails. This is because the traditional firmware upgrade method does not send data packets related to the wireless charging protocol during the firmware upgrade process; after the transmitting end chip times out when receiving the data packet of the charging firmware, the transmission chip stops transmitting energy to the receiving end chip.

Based on this, the present disclosure is to provide a firmware upgrade method, an apparatus, a receiving end device, and a storage medium to ensure that during the firmware upgrade of the receiving end chip, data packets related to the wireless charging protocol are sent to the transmission end chip. This enables the transmitting end chip to continue supplying power to the receiving end chip, thus ensuring a successful firmware upgrade even when the wearable device lacks a reverse power supply circuit and wired interface. The present disclosure saves the system hardware cost of the wearable device and ensures that the wearable devices can meet waterproof requirements.

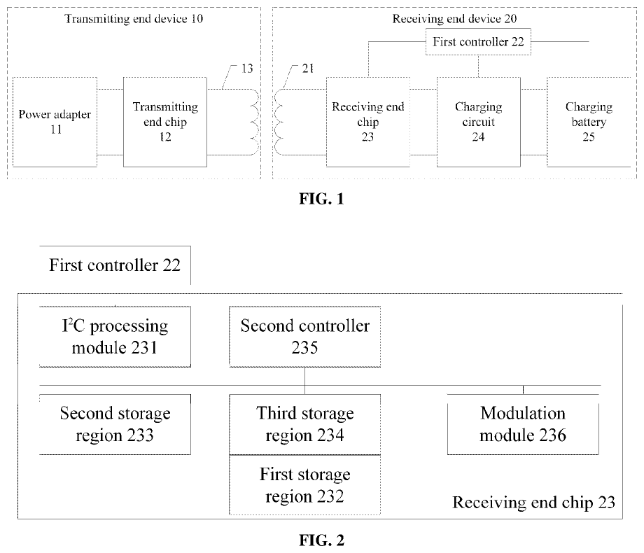

Referring to FIG. 1, FIG. 1 is a structural schematic diagram of a firmware upgrade system provided by the embodiments of the present disclosure. As shown in FIG. 1, the firmware upgrade system includes: a transmitting end device 10 (Tx) and a receiving end device 20 (Rx), wherein the transmitting end device 10 includes: a power adapter 11, a transmitting end chip 12 (Tx IC), and a transmitting end coil 13 (Tx Coil); and the receiving end device 20 includes: a receiving end coil 21 (Rx Coil), a first controller 22, a receiving end chip 23 (Rx IC), a charging circuit 24 (Battery Charger), and a charging battery 25 (Battery).

In the embodiment, the power adapter 11 is configured to connect the mains power supply and the transmitting end chip 12, so as to convert the mains power supply to the voltage required by transmitting end chip 12. The transmitting end coil 13 and the receiving end coil 21 communicate and transmit energy via electromagnetic induction. The receiving end chip 23 obtains energy through the receiving end coil 21 and converts the received AC power into DC power, then controls the charging current and voltage through charging circuit 24 to charge charging battery 25.

The first controller 22 is connected to the receiving end chip 23, the charging circuit 24, and the charging battery 25 via the I2C (inter-integrated circuit) bus. The first controller 22 controls receiving end chip 23 for firmware upgrade and also controls the charging circuit 24 and the charging battery 25 to charge based on the charging program in the charging firmware.

Exemplarily, the first controller 22 can be a micro controller unit (MCU) in wearable devices or an application processor (AP) in mobile terminals that communicate with wearable devices. The second controller 235 can be the MCU in the receiving end chip 23. The embodiment does not impose limitations on this.

Referring to FIG. 2, FIG. 2 is a structural schematic diagram of a receiving end chip provided by the embodiments of the present disclosure. As shown in FIG. 2, the receiving end chip 23 can include at least: an I2C processing module 231, a first storage region 232, a second storage region 233, a third storage region 234, a second controller 235, and a modulation module 236.

The first storage region 232 and the third storage region 234 form the first memory, and the second storage region 233 forms the second memory. The first controller 22 communicates with the first memory, the second memory, and the second controller 235 through the I2C processing module 231. The second controller 235 also communicates with the first memory, the second memory, and the modulation module 236 to obtain data packets and sending timing sequences from the first memory and the second memory, and sends the sending timing sequences of the data packets to the modulation module 236. The modulation module 236 sends the data packets to the transmitting end chip based on the sending timing sequences of the data packets.

Based on the above firmware upgrade system and the structure of the receiving end chip, the following describes the firmware upgrade method applied to the receiving end device in the embodiments provided by the present disclosure.

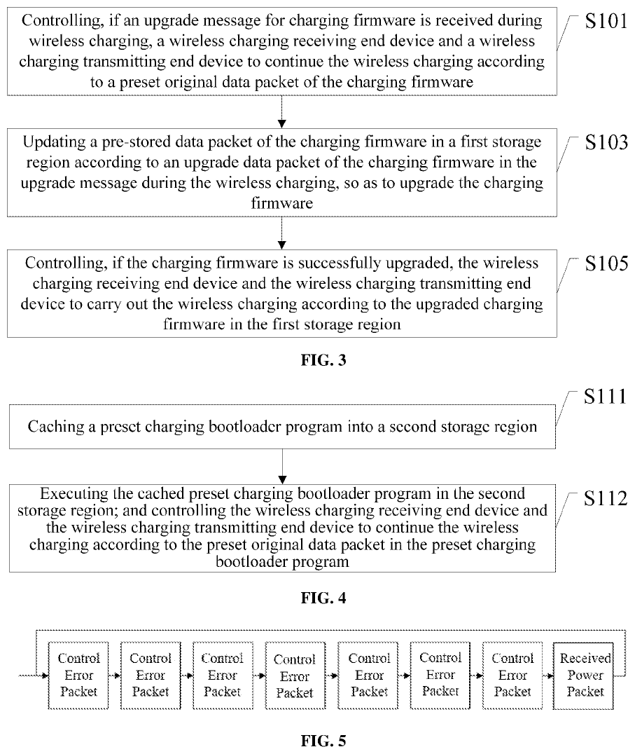

Referring to FIG. 3, FIG. 3 is a flowchart of a firmware upgrade method provided by the embodiments of the present disclosure, first example. As shown in FIG. 3, the method can include the following steps.

S101: controlling, if an upgrade message for charging firmware is received during wireless charging, a wireless charging receiving end device and a wireless charging transmitting end device to continue the wireless charging according to a preset original data packet of the charging firmware;

In the embodiment, the wireless charging process includes placing the receiving end device on the transmitting end device, causing the receiving end coil 21 of the receiving end device to make contact with the transmitting end coil 13 of the transmitting end device. Through the electromagnetic induction between the receiving end coil 21 and the transmitting end coil 13, a power transfer (PT) stage is entered, thus achieving wireless charging of the receiving end device by the transmitting end device.

In the process, the current data packet of the charging firmware stored in the first storage region of the receiving end chip is sent to the transmitting end device to ensure that the receiving end coil 21 and the transmitting end coil 13 enter the PT stage. The current data packet includes the firmware program corresponding to the full wireless charging protocol and charging control logic. The full wireless charging protocol includes: Qi BPP (basic power profile) wireless charging protocol and proprietary charging protocol.

During the wireless charging process, the first controller checks the version of the charging firmware stored in the receiving end chip to determine whether the receiving end chip needs an upgrade.

In some embodiments, the method for detecting whether the receiving end chip requires an upgrade can be: the first controller periodically and actively obtaining the latest charging firmware version of the receiving end device from the device management server, obtaining the current charging firmware version of the receiving end device, and determining whether the latest charging firmware version is consistent with the current charging firmware version to decide whether the receiving end chip requires an upgrade. If the latest charging firmware version is higher than the current charging firmware version, it is determined that the receiving end chip requires an upgrade.

In other embodiments, the method for detecting whether the receiving end chip requires an upgrade can be: the first controller receiving an upgrade message sent by the device management server, wherein the upgrade message is used to instruct the first controller to upgrade the charging firmware in the receiving end chip.

When it is determined that the charging firmware of the receiving end chip requires an upgrade, the second controller obtains the preset original data packet of the charging firmware. The charging firmware is a firmware program related to the wireless charging protocol and charging control logic. The preset original data packet can be the default data packet corresponding to the firmware program of the receiving end chip, such as the data packet corresponding to the firmware program used when the receiving end device was factory-configured or the data packet corresponding to the firmware program currently used by the receiving end device during wireless charging.

In some embodiments, the method for the second controller to obtain the preset original data packet of the charging firmware can be the following. If the preset original data packet is the data packet corresponding to the firmware program used by the receiving end device when factory-configured, the second controller can obtain the preset original data packet from the device management server or store the preset original data packet in the storage medium of the first controller, to obtain the preset original data packet from the storage medium of the first controller.

In another embodiment, the method for the second controller to obtain the preset original data packet of the charging firmware can be the following. If the preset original data packet is the data packet corresponding to the firmware program currently used by the receiving end device during wireless charging, the second controller can obtain the preset original data packet from the receiving end chip.

After obtaining the preset original data packet of the charging firmware, the second controller modulates the preset original data packet through the modulation module and sends the preset original data packet to the transmitting end device using a first preset timing sequence, so that the receiving end device and the transmitting end device maintain communication and energy transmission based on the preset original data packet. The original data packet includes a control error packet (CEP) and a received power packet (RPP).

It should be noted that the transmitting end device and the receiving end device must first generate a wireless charging energy transmission process based on the Qi BPP protocol before maintaining energy transmission according to CEP and RPP. That is, the current data packet is the data packet for generating energy transmission, and the original data packet is the data packet for maintaining energy transmission.

S103: updating a pre-stored data packet of the charging firmware in a first storage region according to an upgrade data packet of the charging firmware in the upgrade message during the wireless charging, so as to upgrade the charging firmware.

In the embodiment, the receiving end device and the transmitting end device maintain communication and energy transmission based on the preset original data packet sent using the first preset timing sequence. During this process, the first controller obtains the upgrade data packet of the charging firmware and loads the obtained upgrade data packet into the first storage region of the receiving end chip to update the data packet of the charging firmware pre-stored in the first storage region with the upgrade data packet, thus completing the upgrade of the charging firmware.

In some embodiments, the method for the first controller to obtain the upgrade data packet of the charging firmware can be the following. If the first controller periodically and actively obtains the latest charging firmware version of the receiving end device from the device management server and determines that the latest charging firmware version is higher than the current charging firmware version, the upgrade data packet corresponding to the latest charging firmware version is obtained from the device management server.

In other embodiments, the method for the first controller to obtain the upgrade data packet of the charging firmware can be the following. If the first controller receives an upgrade message sent by the device management server, where the upgrade message carries the upgrade data packet, the first controller can parse the upgrade message to obtain the upgrade data packet.

S105: controlling, if the charging firmware is successfully upgraded, the wireless charging receiving end device and the wireless charging transmitting end device to carry out the wireless charging according to the upgraded charging firmware in the first storage region.

In the embodiment, after the charging firmware of the receiving end chip is successfully upgraded, the second controller invokes the upgraded charging firmware in the first storage region to run, and sends the upgrade data packet in the upgraded charging firmware to the transmitting end device through a modulation module, so that the receiving end device and the transmitting end device perform communication and energy transmission according to the upgrade data packet.

The firmware upgrade method provided in the above embodiments uses the original data packet to maintain energy transmission between the receiving end device and the transmitting end device during the firmware upgrade of the receiving end chip. The charging firmware upgrade is completed while maintaining energy transmission, thus ensuring a successful firmware upgrade even when the wearable device lacks a reverse power supply circuit and wired interface. This saves the system hardware cost of the wearable device and ensures that the wearable device can meet waterproof requirements.

The following describes a possible implementation of wireless charging based on the preset original charging firmware, in conjunction with FIG. 4 and the embodiments.

Referring to FIG. 4, FIG. 4 is a flowchart of a firmware upgrade method provided by the embodiments of the present disclosure, second example. As shown in FIG. 4, the above step S101 of controlling a wireless charging receiving end device and a wireless charging transmitting end device to continue the wireless charging according to a preset original data packet of the charging firmware can include the following steps.

S111: caching a preset charging bootloader program into a second storage region.

S112: executing the cached preset charging bootloader program in the second storage region; and controlling the wireless charging receiving end device and the wireless charging transmitting end device to continue the wireless charging according to the preset original data packet in the preset charging bootloader program.

In the embodiment, the preset charging bootloader program (Bootloader) is the charging protocol and charging control logic that the receiving end device uses by default when factory-configured. The preset charging bootloader program includes the preset original data packet corresponding to the charging protocol and charging control logic, and the first preset timing sequence for sending the preset original data packet. The first controller writes the preset charging bootloader program into the second storage region through the I2C processing module. After a successful write, the second controller starts running the preset charging bootloader program, obtains the preset original data packet from the preset charging bootloader program, and invokes the modulation module to send the preset original data packet to the transmitting end device according to the first preset timing sequence, thus maintaining energy transmission between the receiving device and the transmitting end device. If the transmitting end device receives the preset original data packet within the preset time, it will continuously transmit energy to the chip of the receiving end device. If the transmitting end device does not receive the preset original data packet within the preset time, it will stop transmitting energy to the chip of the receiving end device.

As an example, referring to FIG. 5, FIG. 5 is a timing sequence diagram of a preset charging bootloader program sending an original data packet. As shown in FIG. 5, multiple CEPs are sent followed by one RPP in a loop to ensure energy transmission maintenance. In the figure, sending 7 CEPs followed by 1 RPP is used as an example.

The firmware upgrade method in the above embodiments writes the charging bootloader program into the second storage region to send the original data packet to the transmitting end device according to the charging bootloader program. This enables the transmitting end device to maintain energy transmission with the receiving end device based on the original data packet, thus completing the upgrade of the charging firmware. This ensures a successful firmware upgrade even when the receiving end device lacks a reverse power supply circuit and wired interface, saves the system hardware cost of the wearable device, and ensures that the wearable devices can meet waterproof requirements.

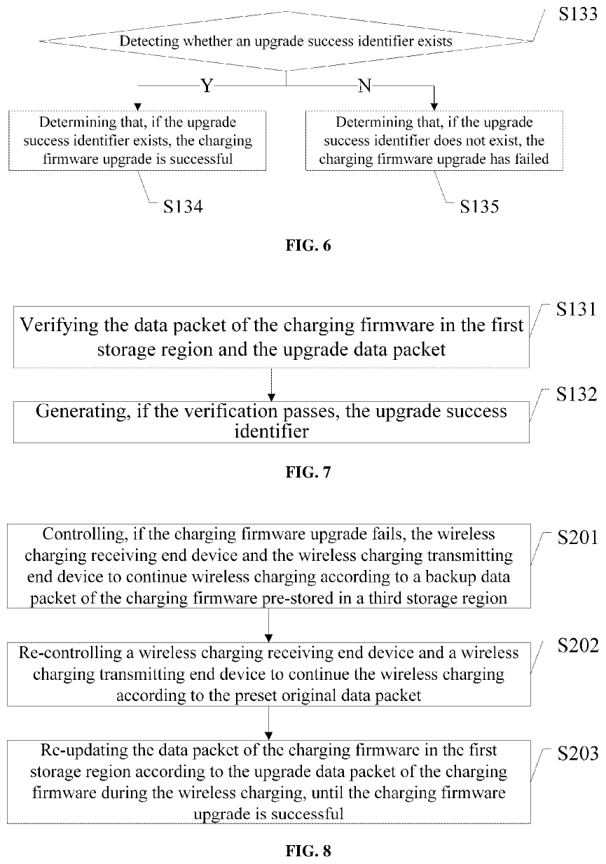

The following describes a possible implementation of detecting whether the charging firmware upgrade is successful in conjunction with FIG. 6.

Referring to FIG. 6, FIG. 6 is a flowchart of a firmware upgrade method provided by the embodiments of the present disclosure, third example. As shown in FIG. 6, after the above step S103 of updating a pre-stored data packet of the charging firmware in a first storage region according to an upgrade data packet of the charging firmware in the upgrade message during the wireless charging, so as to upgrade the charging firmware, the method further includes the following steps.

S133: detecting whether an upgrade success identifier exists.

S134: determining that, if the upgrade success identifier exists, the charging firmware upgrade is successful.

S135: determining that, if the upgrade success identifier does not exist, the charging firmware upgrade has failed.

In the embodiment, after the charging firmware in the first storage region is successfully upgraded, the first controller writes an upgrade success identifier into the preset field. To determine whether the charging firmware upgrade is successful, the preset field is checked for the presence of the upgrade success identifier. If the upgrade success identifier exists, it is determined that the charging firmware upgrade is successful. If the upgrade success identifier does not exist, it is determined that the charging firmware upgrade has failed.

In some embodiments, before each upgrade of the charging firmware, the first controller initializes the preset field, and the preset field is set to a default value. If the upgrade is successful, the default value is rewritten as the upgrade success identifier.

The following describes a possible implementation of generating the upgrade success identifier in conjunction with FIG. 7.

Referring to FIG. 7, FIG. 7 is a flowchart of a firmware upgrade method provided by the embodiments of the present disclosure, fourth example. As shown in FIG. 7, before the above step S133 of detecting whether an upgrade success identifier exists, the method can further include the following steps.

S131: verifying the data packet of the charging firmware in the first storage region and the upgrade data packet.

S132: generating, if the verification passes, the upgrade success identifier.

In the embodiment, the first controller updates the data packets of the charging firmware in the first storage region. After the data packet update is completed, the first controller performs a consistency check between the data packets of the charging firmware and the upgrade data packets in the first storage region. It determines whether the data packets of the charging firmware and the upgrade data packets are consistent. If the data packets of the charging firmware and the upgrade data packets are consistent, the check passes, and an upgrade success identifier is written into the preset field, indicating that the firmware upgrade is successful. If the data packets of the charging firmware and the upgrade data packets are inconsistent, the check fails, and no upgrade success identifier is written into the preset field, indicating that the firmware upgrade has failed.

In some embodiments, the verification method can be a CRC (cyclic redundancy check).

The following describes a possible implementation of an upgrade failure in conjunction with FIG. 8 and the embodiments.

Referring to FIG. 8, FIG. 8 is a flowchart of a firmware upgrade method provided by the embodiments of the present disclosure, fifth example. As shown in FIG. 8, the method can further include the following steps.

S201: controlling, if the charging firmware upgrade fails, the wireless charging receiving end device and the wireless charging transmitting end device to continue wireless charging according to a backup data packet of the charging firmware pre-stored in a third storage region.

S202: re-controlling a wireless charging receiving end device and a wireless charging transmitting end device to continue the wireless charging according to the preset original data packet.

S203: re-updating the data packet of the charging firmware in the first storage region according to the upgrade data packet of the charging firmware during the wireless charging, until the charging firmware upgrade is successful.

In the embodiment, a backup charging firmware is pre-stored in the third storage region. The backup charging firmware includes a backup data packet, and the backup data packet is firmware including the basic Qi BPP wireless charging protocol. If the charging firmware upgrade fails, the current data packet of the charging firmware in the first storage region cannot be used to build energy transmission between the transmitting end device and the receiving end device. In this case, the backup data packet must be used to rebuild energy transmission between the transmitting end device and the receiving end device, thus enabling the receiving end device to enter the PT stage.

In some embodiments, after the first controller determines that the charging firmware upgrade has failed, it notifies the second controller to invoke the backup charging firmware in the third storage region for execution. After the backup data packet in the backup charging firmware is modulated by the modulation module, the backup data packet is sent to the transmitting end chip using the second preset timing sequence, enabling the receiving device to enter the PT stage.

It should be noted that, in addition to the first controller notifying the second controller to invoke the backup charging firmware in the third storage region to run after determining that the charging firmware upgrade has failed, the second controller can also use the same method as the first controller to independently determine whether the charging firmware upgrade is successful.

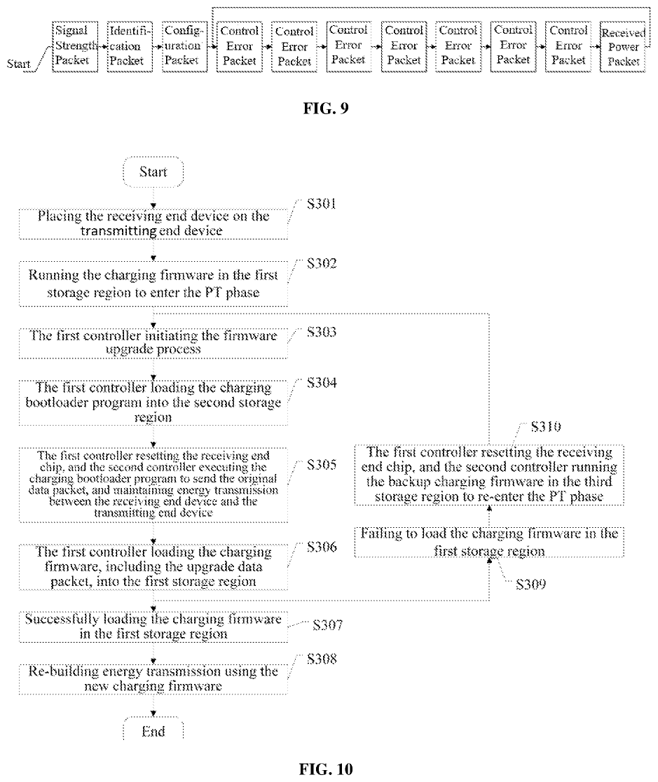

As an example, referring to FIG. 9, FIG. 9 is a timing sequence diagram of sending a backup data packet. As shown in FIG. 9, before building energy transmission using the backup charging firmware, protocol interactions must first be built from the beginning. Therefore, after powering on, it is necessary to send the SSP (signal strength packet), IDP (identification packet), and CFGP (configuration packet) first. Subsequently, the process of sending multiple CEPs followed by one RPP is repeated to maintain energy transmission. In the figure, sending 7 CEPs followed by 1 RPP is used as an example.

After re-building energy transmission based on the backup data packet, to ensure the success of the firmware upgrade, the energy transmission process must remain in a maintained state. Therefore, the original data packet needs to be used again to maintain energy transmission between the receiving end device and the transmitting end device. The specific maintenance process and firmware upgrade process are the same as described in S103 and S105 above and will not be repeated here.

The process of repeatedly executing S201-S203 continues until the charging firmware upgrade is successful.

In some embodiments, the Qi BPP wireless charging protocol in the backup data packet of the third storage unit is the factory-default wireless charging protocol. It can also be the same Qi BPP wireless charging protocol as the current data packet in the first storage unit. If the Qi BPP wireless charging protocol in the backup data packet is the same as the Qi BPP wireless charging protocol in the current data packet of the first storage unit, after the charging firmware in the first storage unit is successfully upgraded, the Qi BPP wireless charging protocol in the backup data packet is updated to the Qi BPP wireless charging protocol in the upgraded charging firmware.

When a firmware upgrade fails during energy transmission built using the data packet in the first storage unit, the firmware upgrade method provided in the above embodiment re-builds energy transmission using the backup data packet in the third storage unit. This ensures that the firmware in the first storage unit can be successfully upgraded.

It should be noted that, in addition to using the backup data packet in the third storage unit to build energy transmission when the charging firmware in the first storage unit fails to upgrade, the backup data packet in the third storage unit can also be used to build energy transmission when the first storage unit is not functioning properly.

In one possible implementation, the first storage region and the third storage region are different storage regions within the first memory, and the first memory is a non-volatile memory. The second storage region is a storage region within the second memory, and the second memory is a random-access memory.

In the embodiment, the first memory is non-volatile memory, which ensures the security of stored data.

The first memory is divided into the first storage region and the third storage region, with the backup data packet stored in the third storage region. This occupies less storage space, saves the cost of chip storage media, and ensures the reliability of the firmware upgrade.

As an example, the first memory can be MTP (multi-time programmable) memory or flash memory.

The second storage region is located in the second memory. The second memory is static random-access memory (SRAM). During each upgrade, the first controller rewrites the preset charging bootloader program into the second memory. After the upgrade is complete, the preset charging bootloader program in the second memory is erased.

Referring to FIG. 10, FIG. 10 is a block diagram of a firmware upgrade method provided by the embodiments of the present disclosure. As shown in FIG. 10, the method can further include the following steps.

S301: placing the receiving end device on the transmitting end device.

S302: running the charging firmware in the first storage region to enter the PT phase.

S303: the first controller initiating the firmware upgrade process.

S304: the first controller loading the charging bootloader program into the second storage region.

S305: the first controller resetting the receiving end chip, and the second controller executing the charging bootloader program to send the original data packet, and maintaining energy transmission between the receiving end device and the transmitting end device.

S306: the first controller loading the charging firmware, including the upgrade data packet, into the first storage region.

S307: successfully loading the charging firmware in the first storage region.

S308: re-building energy transmission using the new charging firmware.

S309: failing to load the charging firmware in the first storage region.

S310: the first controller resetting the receiving end chip, and the second controller running the backup charging firmware in the third storage region to re-enter the PT phase, and continuing executing S303 to S306.

Based on the above method embodiment, the embodiments of the present disclosure provide a firmware upgrade apparatus, which is applied to a wireless charging receiving end device. Referring to FIG. 11, FIG. 11 is a schematic structural diagram of a firmware upgrade apparatus provided by the embodiments of the present disclosure. As shown in FIG. 11, the apparatus can further include:
a first charging control module 101, configured for controlling, if an upgrade message for charging firmware is received during wireless charging, a wireless charging receiving end device and a wireless charging transmitting end device to continue the wireless charging according to a preset original data packet of the charging firmware;
a data packet updating module 102, configured for updating a pre-stored data packet of the charging firmware in a first storage region according to an upgrade data packet of the charging firmware in the upgrade message during the wireless charging, so as to upgrade the charging firmware; and
a second charging control module 103, configured for controlling, if the charging firmware is successfully upgraded, the wireless charging receiving end device and the wireless charging transmitting end device to carry out the wireless charging according to the upgraded charging firmware in the first storage region.

Optionally, the first charging control module 101 includes
a caching unit, configured for caching a preset charging bootloader program into a second storage region; and
a charging control unit, configured for executing the cached preset charging bootloader program in the second storage region; and controlling the wireless charging receiving end device and the wireless charging transmitting end device to continue the wireless charging according to the preset original data packet in the preset charging bootloader program.

Optionally, after the data packet updating module 102, the apparatus further includes
a detection module, configured for detecting whether an upgrade success identifier exists;
a determination module, configured for determining that, if the upgrade success identifier does not exist, the charging firmware upgrade has failed; and further configured for determining that, if the upgrade success identifier does not exist, the charging firmware upgrade has failed.

Optionally, before the detection module, the apparatus further includes:
a verification module, configured for verifying the data packet of the charging firmware in the first storage region and the upgrade data packet; and
a generation module, configured for generating, if the verification passes, the upgrade success identifier.

Optionally, the apparatus further includes
a third charging control module, configured for controlling, if the charging firmware upgrade fails, the wireless charging receiving end device and the wireless charging transmitting end device to continue wireless charging according to a backup data packet of the charging firmware pre-stored in a third storage region.

The first charging control module 101 is further configured for re-controlling a wireless charging receiving end device and a wireless charging transmitting end device to continue the wireless charging according to the preset original data packet.

The data packet updating module 102 is further configured for re-updating the data packet of the charging firmware in the first storage region according to the upgrade data packet of the charging firmware during the wireless charging, until the charging firmware upgrade is successful.

Optionally, the first storage region and the third storage region are different storage regions within the first memory, and the first memory is a non-volatile memory.

Optionally, the second storage region is a storage region within the second memory, and the second memory is a random-access memory.

The above-mentioned device is configured to execute the method provided in the previous embodiments. Its implementation principles and technical effects are similar and will not be reiterated here.

The above-mentioned modules can be configured as one or more integrated circuits to implement the above method, for example, one or more application-specific integrated circuits (ASIC), one or more microprocessors, or one or more field programmable gate arrays (FPGA), among others. For example, when one of the aforementioned modules is implemented in the form of processing element scheduler code, the processing element can be a general-purpose processor, such as a central processing unit (CPU), or another processor capable of executing program code. Furthermore, these modules can be integrated together in the form of a system-on-a-chip (SOC).

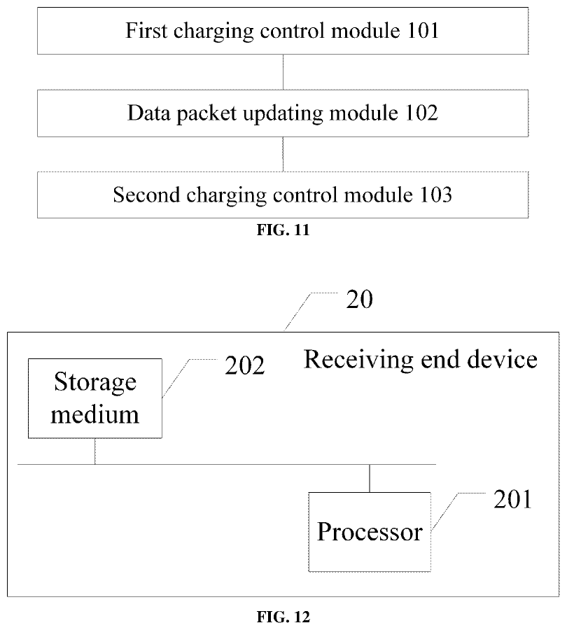

Referring to FIG. 12, FIG. 12 is a structural schematic diagram of a receiving end device provided by the embodiments of the present disclosure. As shown in FIG. 12, the receiving end device 20 includes: a processor 201, a storage medium 202, and a bus. The storage medium 202 stores program instructions executable by the processor 201. When the receiving end device 20 operates, the processor 201 communicates with the storage medium 202 via the bus. The processor 201 executes the program instructions to implement the method embodiments described above. The specific implementation and technical effects are similar and will not be repeated here.

Optionally, the embodiment of the present disclosure also provides a computer-readable storage medium, wherein the storage medium stores a computer program. The computer program performs the embodiments of the method as described above when run by a processor.

In the several embodiments provided in the present disclosure, it should be understood that the devices and methods disclosed can be implemented in other ways. For example, the above-described embodiments of the device are merely schematic. For example, the division of the units described, which is only a logical functional division, can be divided in another way when actually implemented; and for another example, multiple units or components can be combined or integrated into another system, or some features can be ignored or not implemented. On another point, the mutual coupling, direct coupling, or communication connection shown or discussed herein can be an indirect coupling or communication connection through interfaces, devices, or units, which can be electrical, mechanical, or other forms.

The units described as separate components may or may not be physically separate, and the components displayed as units may or may not be physical units, meaning they can be located in one place or distributed across multiple network units. Some or all of the units can be selected as needed to achieve the objectives of the embodiments of the present disclosure.

Further, each functional unit in each embodiment of the present disclosure can be integrated into a single processing unit, each unit can be physically present separately, or two or more units can be integrated into a unit. The integrated units mentioned above can be implemented both in hardware and in the form of hardware combined with software functional units.

The integrated units implemented in the form of software functional units can be stored on a computer-readable storage medium. The software functional units, stored on a storage medium, comprise various instructions that enable a computer device (such as a personal computer, server, or network device) or processor to execute certain steps of the methods provided in various embodiments of the present disclosure. The aforementioned storage media include various media that can store program code, such as USB drives, external hard drives, read-only memory (ROM), random access memory (RAM), disks, or optical discs.

The above are only specific embodiments of the present disclosure, but the scope of protection of the present disclosure is not limited thereto. Any person skilled in the art can easily envisage changes or substitutions within the technical scope disclosed in the present disclosure, which should be encompassed within the scope of protection of the present disclosure. Therefore, the scope of protection of the present disclosure shall be stated to be subject to the scope of protection of the claims.

### INDUSTRIAL PRACTICALITY

The above solution uses the original data packet to maintain energy transmission between the receiving end device and the transmitting end device during the firmware upgrade of the receiving end chip. The charging firmware upgrade is completed while maintaining energy transmission, thus ensuring a successful firmware upgrade even when the wearable device lacks a reverse power supply circuit and wired interface. This saves the system hardware cost of the wearable device and ensures that the wearable device can meet waterproof requirements, which has a better practicability.

1. A firmware upgrade method, applicable to a wireless charging receiving end device, wherein the method comprises:
controlling, when an upgrade message for charging firmware is received during wireless charging, the wireless charging receiving end device and a wireless charging transmitting end device to continue the wireless charging according to a preset original data packet of the charging firmware;
updating a pre-stored data packet of the charging firmware in a first storage region according to an upgrade data packet of the charging firmware in the upgrade message during the wireless charging, so as to upgrade the charging firmware; and
controlling, when the charging firmware is successfully upgraded, the wireless charging receiving end device and the wireless charging transmitting end device to carry out the wireless charging according to an upgraded charging firmware in the first storage region.

2. The method according to claim 1, wherein the step of controlling the wireless charging receiving end device and a wireless charging transmitting end device to continue the wireless charging according to a preset original data packet of the charging firmware comprises:
caching a preset charging bootloader program into a second storage region;
executing the cached preset charging bootloader program in the second storage region;
and controlling the wireless charging receiving end device and the wireless charging transmitting end device to continue the wireless charging according to the preset original data packet in the preset charging bootloader program.

3. The method according to claim 1, wherein after the step of updating a pre-stored data packet of the charging firmware in a first storage region according to an upgrade data packet of the charging firmware in the upgrade message during the wireless charging, so as to upgrade the charging firmware, the method further comprises:
detecting whether an upgrade success identifier exists;
determining that, when the upgrade success identifier exists, a charging firmware upgrade is successful; and
determining that, when the upgrade success identifier does not exist, the charging firmware upgrade has failed.

4. The method according to claim 3, wherein before the step of detecting whether an upgrade success identifier exists, the method further comprises:
verifying a data packet of the charging firmware in the first storage region and the upgrade data packet; and
generating, when the verifying passes, the upgrade success identifier.

5. The method according to claim 3, wherein the method further comprises:
controlling, when the charging firmware upgrade fails, the wireless charging receiving end device and the wireless charging transmitting end device to continue the wireless charging according to a backup data packet of the charging firmware pre-stored in a third storage region;
re-controlling the wireless charging receiving end device and the wireless charging transmitting end device to continue the wireless charging according to the preset original data packet; and
re-updating a data packet of the charging firmware in the first storage region according to the upgrade data packet of the charging firmware during the wireless charging, until the charging firmware upgrade is successful.

6. The method according to claim 5, wherein the first storage region and the third storage region are different storage regions within a first memory, and the first memory is a non-volatile memory.

7. The method according to claim 2, wherein the second storage region is a storage region within a second memory, and the second memory is a random-access memory.

8. The method according to claim 2, wherein the preset charging bootloader program comprises the preset original data packet corresponding to a charging protocol and a charging control logic; and a first preset timing sequence for sending the preset original data packet; and the step of executing the cached preset charging bootloader program in the second storage region; and controlling the wireless charging receiving end device and the wireless charging transmitting end device to continue the wireless charging according to the preset original data packet in the preset charging bootloader program comprises:
starting running the preset charging bootloader program, obtaining the preset original data packet from the preset charging bootloader program, and sending the preset original data packet to the transmitting end device according to the first preset timing sequence to maintain energy transmission between the receiving end device and the transmitting end device.

9. The method according to claim 5, wherein the step of controlling the wireless charging receiving end device and the wireless charging transmitting end device to continue the wireless charging according to a backup data packet of the charging firmware pre-stored in a third storage region comprises:
invoking the backup data packet for execution, and sending the backup data packet to the transmitting end device according to a second preset timing sequence to maintain energy transmission between the receiving end device and the transmitting end device.

10. A firmware upgrade system, wherein the firmware upgrade system comprises a transmitting end device and a receiving end device; the transmitting end device comprises a power adapter, a transmitting end chip, and a transmitting end coil; and the receiving end device comprises a receiving end coil, a first controller, a receiving end chip, a charging circuit, and a charging battery;
the power adapter is configured to connect a mains power supply and the transmitting end chip; the transmitting end coil and the receiving end coil communicate and transmit energy via electromagnetic induction; the receiving end chip obtains energy through the receiving end coil, converts a received AC power into DC power, and controls a charging current and a voltage through the charging circuit to charge the charging battery;
the first controller is connected to the receiving end chip, the charging circuit, and the charging battery through an I2C bus; and
the receiving end device is configured to execute the firmware upgrade method according to claim 1 to control the receiving end chip for firmware upgrading.

11. A firmware upgrade apparatus, applicable to a wireless charging receiving end device, wherein the apparatus comprises:
a first charging control module, configured for controlling, when an upgrade message for charging firmware is received during wireless charging, the wireless charging receiving end device and a wireless charging transmitting end device to continue wireless charging according to a preset original data packet of the charging firmware;
a data packet updating module, configured for updating a pre-stored data packet of the charging firmware in a first storage region according to an upgrade data packet of the charging firmware in the upgrade message during the wireless charging, so as to upgrade the charging firmware; and
a second charging control module, configured for controlling, when the charging firmware is successfully upgraded, the wireless charging receiving end device and the wireless charging transmitting end device to carry out the wireless charging according to an upgraded charging firmware in the first storage region.

12. The apparatus according to claim 11, wherein the first charging control module comprises:
a caching unit, configured for caching a preset charging bootloader program into a second storage region; and
a charging control unit, configured for executing the cached preset charging bootloader program in the second storage region; and controlling the wireless charging receiving end device and the wireless charging transmitting end device to continue the wireless charging according to the preset original data packet in the preset charging bootloader program.

13. The apparatus according to claim 11, wherein the apparatus further comprises:
a third charging control module, configured for controlling, when a charging firmware upgrade fails, the wireless charging receiving end device and the wireless charging transmitting end device to continue the wireless charging according to a backup data packet of the charging firmware pre-stored in a third storage region; and
the first charging control module is further configured for re-controlling the wireless charging receiving end device and the wireless charging transmitting end device to continue the wireless charging according to the preset original data packet; and
the data packet updating module is further configured for re-updating a data packet of the charging firmware in the first storage region according to the upgrade data packet of the charging firmware during the wireless charging, until the charging firmware upgrade is successful.

14. A receiving end device, comprising a processor, a storage medium, and a bus, wherein the storage medium stores program instructions executable by the processor; when the receiving end device operates, the processor communicates with the storage medium via the bus, and the processor executes the program instructions to perform the steps of the firmware upgrade method according to claim 1.

15. A computer-readable storage medium, wherein the storage medium stores a computer program, and when executed by a processor, the computer program performs the steps of the firmware upgrade method according to claim 1.

16. The firmware upgrade system according to claim 10, wherein the step of controlling the wireless charging receiving end device and a wireless charging transmitting end device to continue the wireless charging according to a preset original data packet of the charging firmware comprises:
caching a preset charging bootloader program into a second storage region;
executing the cached preset charging bootloader program in the second storage region;
and controlling the wireless charging receiving end device and the wireless charging transmitting end device to continue the wireless charging according to the preset original data packet in the preset charging bootloader program.

17. The firmware upgrade system according to claim 10, wherein after the step of updating a pre-stored data packet of the charging firmware in a first storage region according to an upgrade data packet of the charging firmware in the upgrade message during the wireless charging, so as to upgrade the charging firmware, the method further comprises:
detecting whether an upgrade success identifier exists;
determining that, when the upgrade success identifier exists, a charging firmware upgrade is successful; and
determining that, when the upgrade success identifier does not exist, the charging firmware upgrade has failed.

18. The firmware upgrade system according to claim 17, wherein before the step of detecting whether an upgrade success identifier exists, the method further comprises:
verifying a data packet of the charging firmware in the first storage region and the upgrade data packet; and
generating, when the verifying passes, the upgrade success identifier.

19. The firmware upgrade system according to claim 17, wherein the method further comprises:
controlling, when the charging firmware upgrade fails, the wireless charging receiving end device and the wireless charging transmitting end device to continue the wireless charging according to a backup data packet of the charging firmware pre-stored in a third storage region;
re-controlling the wireless charging receiving end device and the wireless charging transmitting end device to continue the wireless charging according to the preset original data packet; and
re-updating a data packet of the charging firmware in the first storage region according to the upgrade data packet of the charging firmware during the wireless charging, until the charging firmware upgrade is successful.

20. The firmware upgrade system according to claim 19, wherein the first storage region and the third storage region are different storage regions within a first memory, and the first memory is a non-volatile memory.
